(19) United States
(12) Patent Application Publication
(10) Pub. No.: US 2026/0216708 A1
(43) Pub. Date: Jul. 30, 2026

(54) CATALYST COMPOSITION WITH REDOX-ACTIVE SUPPORT FOR SIMULTANEOUS OXYGEN AND NITROGEN REMOVAL

(71) Applicant: NESTE OYJ, Espoo (FI)

(72) Inventors: Emma VERKAMA, Porvoo (FI); Riikka PUURUNEN, Porvoo (FI); Reetta KARINEN, Porvoo (FI); Aitor ARANDIA, Porvoo (FI); Sylvia ALBERSBERGER, Porvoo (FI); Marja TIITTA, Porvoo (FI); Susanna WALLENIUS, Porvoo (FI)

(21) Appl. No.: 19/141,827

(22) PCT Filed: Sep. 28, 2023
(86) PCT No.: PCT/FI2023/050552

§ 371 Date: Jun. 20, 2025

(30) Foreign Application Priority Data
Dec. 21, 2022 (FI) 20226143

(51) Int. Cl. B01J 23/89; C10G 65/02

(52) U.S. Cl. CPC B01J 23/894; C10G 65/02; C10G 2300/1003; C10G 2300/202; C10G 2300/4006; C10G 2300/4012; C10G 2300/70

(57) ABSTRACT

The invention relates to a method for simultaneously lowering oxygen and nitrogen content in a feedstock, the feedstock comprising renewable and/or recycled feedstock for producing paraffinic hydrocarbons. The method uses a catalyst comprising at least one active metal and a support capable of undergoing reversible redox reactions during the production of the paraffinic hydrocarbons, the support comprising at least one of cerium dioxide and niobium pentoxide.

### FIELD OF THE INVENTION

The present invention relates to a method for treating renewable and/or recycled feedstock using a catalyst, as well as to the use of such a catalyst.

### BACKGROUND AND OBJECTS

Renewable hydrocarbons, such as the ones suitable for use as transportation fuels, can be produced through a catalytic hydrotreatment of bio-based, i.e. renewable feedstock or recycled feedstock, where the main target is to decrease the impurity content of the feedstock, to meet the required properties of the fuel standards and to yield a product which is chemically similar to e.g. fossil fuels.

Renewable fuels may also be produced from bio-based waste feedstocks, which contain, in addition or alternatively, also different nitrogen-containing compounds than the fossil-based feedstocks processed traditionally in refineries. Feedstock originating from low quality sources, such as waste and residue materials, additionally include various amounts of nitrogen-containing compounds, which in addition to causing NOx emissions, are incompatible with downstream processing units in refineries due to their reactivity and tendency to deactivate catalysts. Nitrogen-containing compounds can indeed cause severe decrease in activity and a shortened lifetime of the catalysts, not only of the hydrotreating catalysts for deoxygenation but also in the catalytic units after hydrotreatment, such as isomerisation or cracking. Decreasing the nitrogen content of renewable feedstock is thus desired, in parallel with oxygen removal.

It is therefore an object of the present invention to provide catalysts that can decrease or remove both oxygen and nitrogen content from the feedstock, as well as a method for simultaneously lowering the amount of oxygen and nitrogen in the feedstock, whether in a different, or, in particular, in the same molecule. A further aim is to obtain a high conversion of the feed as well as a good yield of the produced paraffins with a high selectivity towards the desired paraffins.

### SUMMARY

According to an aspect, the present description relates to a method for simultaneously lowering oxygen and nitrogen content in a feedstock, the feedstock comprising renewable and/or recycled feedstock for producing paraffinic hydrocarbons, wherein a catalyst comprising at least one active metal and a support capable of undergoing reversible redox reactions is used during the production of the paraffinic hydrocarbons, the support comprising at least one of cerium dioxide and niobium pentoxide.

According to another aspect, the present description relates to use of a catalyst comprising at least one active metal and a support capable of undergoing reversible redox reactions for simultaneously lowering oxygen and nitrogen content in a renewable and/or recycled feedstock, the support comprising at least one of cerium dioxide and niobium pentoxide.

### BRIEF DESCRIPTION OF THE DRAWING

FIG. 1 illustrates temperature programmed reduction profiles of some catalysts.

### DETAILED DESCRIPTION

The invention is defined by the features of the independent claims. Some specific embodiments are defined in the dependent claims.

According to an aspect, there is provided a method for simultaneously lowering oxygen and nitrogen content in a feedstock, the feedstock comprising renewable and/or recycled feedstock for producing paraffinic hydrocarbons, wherein a catalyst comprising at least one active metal and a support capable of undergoing reversible redox reactions is used during the production of the paraffinic hydrocarbons, the support comprising at least one of cerium dioxide and niobium pentoxide.

The present description, thus, relates to the use of catalysts that are active for simultaneously lowering the amount of oxygen and the amount of nitrogen, both in the case where the nitrogen and oxygen are in the same molecule and in case where they are in different molecules. This is shown below in the Experimental part, using an aliphatic amide (containing oxygen and nitrogen heteroatoms) and an aliphatic amine (containing nitrogen heteroatoms) as model compounds for the activity tests.

The present method allows for a high conversion as well as a good yield of paraffins. Typically, the amount of oxygen and nitrogen will be at most 10 ppm, preferably 5 ppm, more preferably 1 ppm, or most preferably even less, such as below 0.5 ppm (by weight), in the resulting paraffinic hydrocarbon product. A person skilled in the art, knowing the oxygen and nitrogen content of the feedstock to be used is readily able to adjust the process conditions, such as flow rates, to such a value that at least very close to full conversion of the relevant feedstock molecules to paraffinic hydrocarbons is obtained, and thus, the present catalyst allows to reach these desired low levels of oxygen and nitrogen in the hydrocarbon product.

The amount of oxygen may be lowered by hydrodeoxygenation (HDO) and/or hydrodecarboxylation (DCO) and/or hydrodecarbonylation, while the amount of nitrogen may be lowered by hydrodenitrogenation (HDN), either by direct denitrogenation and/or hydrogenolysis.

The present method is particularly useful for treating renewable or recycled feedstocks that contain nitrogen-containing impurities, such as amides, in addition to oxygen-containing impurities. The presently used isomerisation catalysts typically get deactivated by e.g., amides, and once the catalyst is deactivated beyond a pre-set value or criteria, the catalyst needs to be changed, which typically causes a shutdown in the process. Furthermore, the product quality may suffer from the catalyst deactivation.

In the present description, weight percentages (wt-%) are calculated on the total weight of the material in question. Volume percentages (vol-%) are also calculated on the total volume of the material in question. Any amounts defined as ppm (parts per million) are based on weight. Further, in this description, “at least one” means that there is one or more of the items mentioned, such as two, three, four, five, six, or more. The terms “feed” and “feedstock” may be used interchangeably. When the term “removal” is used, it is meant that the amount of the compound or atom in question is decreased or lowered, not necessarily that all such compounds or atoms are fully removed.

Renewable organic compounds can be differentiated chemically from those of fossil origin, including hydrocarbons, by suitable method for analysing the content of carbon from renewable sources, such as DIN 51637 (2014), ASTM D6866 (2020) and EN 16640 (2017). Said methods are based on the fact that carbon atoms of renewable or biological origin comprise a higher number of unstable radiocarbon (¹⁴C) atoms compared to carbon atoms of fossil origin. Therefore, it is possible to distinguish between carbon compounds derived from renewable or biological sources or raw material and carbon compounds derived from fossil sources or raw material by analysing the ratio of ¹²C and ¹⁴C isotopes. Thus, a particular ratio of said isotopes can be used as a “tag” to identify a renewable carbon compound and differentiate it from non-renewable carbon compounds. The isotope ratio does not change in the course of chemical reactions. Therefore, the isotope ratio can be used for identifying renewable compounds, components, and compositions and distinguishing them from non-renewable, fossil materials in reactor feeds, reactor effluents, separated product fractions and various blends thereof.

Numerically, the biogenic carbon content can be expressed as the amount of biogenic carbon in the material as a weight percent of the total carbon (TC) in the material (in accordance with ASTM D6866 (2020) or EN 16640 (2017)). In the present context, the term renewable preferably refers to a material having a biogenic carbon content of more than 95 wt-%, even more preferably about 100 wt-%, based on the total weight of carbon in the material (EN 16640 (2017)).

As used herein the term “recycled feedstock” refers to carbon-containing materials that have been processed into form suitable for use as feedstock for producing hydrocarbons. In one embodiment, the recycled feedstock comprises liquefied waste plastics (LWP), municipal solid waste (MSW), originating from waste streams of industry, and synthetic hydrocarbons (originating from recycled material, for example manufactured from carbon dioxide or flue gas). The hydrogen and carbon in a synthetic hydrocarbon may be recycled from industrial processes, gasification of recycled material wherein some of the carbons being biogenic, some of fossil origin. Recycled plastics may be converted into liquid feedstock by, e.g., pyrolysis, similarly comprising biogenic carbon, fossil carbon or mixtures thereof. In addition to aliphatic O- and N-containing compounds, recycled feedstocks typically contain varying types of aromatic O- and N-containing compounds, such as phenols, furane, pyrrols, pyridine, indoles, and the like.

As used herein the term “hydrocarbons” refers to compounds comprising carbon and hydrogen, especially to paraffins, n-paraffins, i-paraffins, monobranched i-paraffins, multiple-branched i-paraffins, olefins, naphthenes and aromatics.

As used herein, Cn hydrocarbons, Cn paraffins, or Cn isoparaffins refer to hydrocarbons, paraffins, or isoparaffins, respectively, having a carbon number of n, where n is any feasible integer.

The term “redox reaction” in the context of catalytic reactions has its generally used meaning that an oxidation-reduction a.k.a. redox reaction is a reaction that involves the transfer of electrons between chemical species, such as the atoms, ions, or molecules involved in the reaction. During a redox reaction, some species undergo oxidation, i.e. the loss of electrons or electron density, while others undergo reduction, i.e. the gain of electrons. Redox reactions are of particular interest for catalytic materials as redox-active transition metal compounds may be used due to their rich chemistry and their beneficial physical and chemical properties.

The supports of the catalysts used herein, i.e. “redox-supports”, are redox-active. The metal cations of such supports can exist in different oxidation states, and redox-active supports are capable of undergoing reversible reduction and oxidation cycles during the reaction. The catalyst support, thus, enables electron transfer reactions. The catalyst supports can have an affinity for oxygen, an affinity for nitrogen or both. It was observed that the present catalysts are more active in HDO and HDN reactions than catalysts using a support with non-redox active oxides.

The terms “active metal” and “metal” may be used interchangeably and refer to the active metal or metals that is or are used together with the redox-support, i.e. the terms “metal” or “active metal” do not refer to the metal oxide of the support.

According to an embodiment, the support is selected from a group consisting of cerium dioxide, cerium dioxide-zirconium dioxide, cerium dioxide-alumina, cerium dioxide-silica, niobium pentoxide, niobium pentoxide-zirconium dioxide, niobium pentoxide-alumina, niobium pentoxide-silica and mixtures of at least two of cerium dioxide, niobium pentoxide, and titanium dioxide, with or without at least one of zirconium dioxide, alumina, and silica.

In an embodiment, the support comprises at least one support metal oxide, wherein the support metal of said metal oxide is able to change its oxidation state. Such support metal oxide may also be used together with zirconium dioxide, silica and/or alumina. In such a case, the amount of the support metal oxide able to change its oxidation state is over 1 wt-% of the total weight of the support, preferably 1-40 wt-% of the total weight of the support, more preferably 10-30 wt-% of the total weight of the support, or 5-20 wt-% of the total weight of the support. The amount of the support metal oxide able to change its oxidation state in the catalyst support has an influence on the reactivity of the catalyst towards nitrogen and oxygen atoms, and hence on the activity of the catalyst.

When cerium dioxide and/or niobium pentoxide is used in combination with alumina or silica, the amount of cerium dioxide and/or niobium pentoxide is typically over 1 wt-% of the total weight of the support, preferably 1-30 wt-% of the total weight of the support, or 5-20 wt-% of the total weight of the support.

The support metals comprise at least one of cerium, niobium, either alone or in combination, or titanium together with cerium and/or niobium, i.e. the support metal may be cerium alone, cerium with niobium, cerium with titanium, cerium with niobium and titanium, niobium alone, or niobium with titanium.

According to an embodiment, the support is selected from cerium dioxide-zirconium dioxide, and mixtures of at least two of cerium dioxide-zirconium dioxide, niobium pentoxide, and titanium dioxide.

The cerium cation in ceria (cerium dioxide CeO₂) has an ability to undergo rapid reversible changes between oxidation states +4 and +3. Zirconia (zirconium dioxide ZrO₂) per se is not considered here as redox-active, but, e.g., by doping zirconia with CeO₂, the reducibility of ZrO₂ can be notably increased. Niobium pentoxide (Nb₂O₅) also has an intrinsic redox potential, in addition to displaying acid properties. By doping is meant herein mixing two or more different compounds.

Nitrogen and oxygen removal reactions yield at least NH₃ and H₂O, respectively, in hydrotreatment reactions, as well as possibly CO and CO₂. In the aforementioned molecules, nitrogen and oxygen are present in their lowest possible oxidation state, i.e. −2 for oxygen and −3 for nitrogen. During the reactions, hydrogen and carbon may be oxidised, e.g. hydrogen can be oxidised from oxidation state 0 to +1 in NH₃ and H₂O. Without wishing to be bound by a theory, the redox-active catalyst supports are believed to weaken the carbon-oxygen and carbon-nitrogen bond in the molecule(s) of the feedstock by electron transfer and/or stabilise possible intermediates, and thus facilitate the carbon-oxygen and carbon-nitrogen bond splitting.

For the present description, γ-Al₂O₃ and ZrO₂ were chosen as comparative support materials for the comparative catalysts. Both γ-Al₂O₃ and ZrO₂ are well-known catalyst supports with acidic properties, specifically Lewis acidity. Neither γ-Al₂O₃ nor ZrO₂ are able to undergo oxidation state changes, in the reaction conditions of the present process, at least to a sufficient degree, when catalytic reactions occur on their surface and are thus considered non-redox active, and therefore used as comparative support materials in this disclosure.

According to an embodiment, the support is selected from cerium dioxide-zirconium dioxide, niobium pentoxide, mixtures thereof, and mixtures thereof with titanium dioxide. In such mixtures of cerium dioxide and zirconium dioxide, the amount of cerium dioxide can be for example 10-40 wt-% of the total weight of the support, the rest being zirconium dioxide. Indeed, the HDN and HDO activity can be further improved by doping the ZrO₂ support with CeO₂. Without wishing to be bound to a theory, it is believed that it is rather the CeO₂ that changes its oxidation state, than ZrO₂. There may be changes in the crystal structure originating from the partial substitution of larger cerium ions by smaller zirconium ions. The changes of the cubic lattice cell may result in a crystalline structure distortion that is anticipated to favour the formation of defects by releasing the structural stress. On the more active CeO₂-ZrO₂ support and with an optimised active metal loading, the activity level of e.g. nickel is competitive with the noble metals.

In supports comprising more than one type of oxide, the amounts of the different oxides can be freely chosen. Some suitable combinations are CeO₂-doped ZrO₂ with 25 wt-% of CeO₂ and CeO₂-doped ZrO₂ with 17 wt-% of CeO₂.

According to an embodiment, the active metal comprises one active metal, i.e. atoms of one metal, and can be called a monometallic catalyst.

According to another embodiment, the active metal comprises two active metals, i.e. atoms of two different metals, and can be called a bimetallic catalyst.

According to yet a further embodiment, the active metal comprises more than two active metals, i.e. atoms of more than two different metals, such as atoms of three, four or five different metals, most typically atoms of three different metals. These catalysts can be called multimetallic catalysts.

According to an embodiment, the active metal(s) is selected from noble metals, transition metals, and combinations thereof. The transition metal may be selected from a group consisting of cobalt, tungsten, nickel, and molybdenum. The noble metal may be selected from a group consisting of platinum, rhodium, ruthenium, and palladium. In a further embodiment, the active metal is selected from a group consisting of combinations of cobalt, tungsten, nickel, molybdenum, platinum, rhodium, ruthenium, and palladium. According to a particularly preferred embodiment, the active metal is ruthenium. Another particularly preferred embodiment is the Ru/CeO₂—ZrO₂ catalyst. Still another particularly preferred embodiment is the RuNi/CeO₂—ZrO₂ catalyst. A particularly preferred embodiment is ruthenium as active metal, alone or with another metal, on any support capable of undergoing reversible redox reactions, i.e. a catalyst comprising ruthenium as active metal on a support capable of undergoing reversible redox reactions.

When platinum is used as the active metal in this type of catalysts, it may form C2n condensation products, due to its nature. This was particularly pronounced for the Pt/Nb₂O₅ catalysts due to the acid properties of the support.

As opposed to fossil feeds which have inherent high sulfur content, the renewable feeds are typically low in S, such as sulfur-free compounds. Some advantages of the noble metal catalysts is that there is no need for sulfiding them during start-up of the process and no need to add sulfur-containing compounds into the gas phase during the reaction. Using transition metal sulfide catalysts typically requires sulfur addition contrary to noble metal catalysts. Some advantages of the transition metal sulfide catalysts are that they are more tolerant to sulfur-, nitrogen-, oxygen- and halogen-containing compounds, and thus, there can be more of these impurities in the feed.

Thus, according to one embodiment, the catalyst comprises one active metal on a support capable of undergoing reversible redox reactions during the production of the paraffinic hydrocarbons. According to another embodiment, the catalyst comprises two active metals on a support capable of undergoing reversible redox reactions during the production of the paraffinic hydrocarbons. According to a still further embodiment, the catalyst comprises two active metals on a support capable of undergoing reversible redox reactions during the production of the paraffinic hydrocarbons and the catalyst is sulfided prior to or during the production of the paraffinic hydrocarbons. Indeed, the catalyst can be mono-, bi-, or multimetallic, and it may require sulfidation or not, independently from the number of active metal(s).

According to an embodiment, the catalyst comprises one or two or more than two active metals on a support capable of undergoing reversible redox reactions during the production of the paraffinic hydrocarbons, wherein the catalyst is sulfided prior to or during the production of the paraffinic hydrocarbons.

Indeed, various active metals were tested on different supports and it was observed that for example platinum-containing catalysts supported on oxides capable of undergoing reversible oxidation-reduction reactions (see the results for Nb₂O₅ and 25 wt-% CeO₂/75 wt-% ZrO₂), are more active in simultaneous nitrogen and oxygen removal, than the conventional platinum catalysts supported on non-redox supports. The comparative catalysts were prepared with the same methods and share similar platinum content and platinum particle sizes. Thus, the results are believed to be reliable and comparable.

When using noble metals, no sulfidation of the metal is required. In such a case, also the feedstock is preferably sulfur free or has a very low content of sulfur for avoiding deactivation of the catalyst. Some renewable feedstocks, such as algae oils, are naturally free from sulfur.

It has been observed that bimetallic catalysts, such as RuNi and PtNi, have very good activity while simultaneously removing oxygen and nitrogen. These catalysts typically produce the Cn-1 paraffin with a higher activity and selectivity than what would be anticipated from the activities of the corresponding monometallic catalysts. It is, thus, believed that the combination of the noble metal and nickel leads to a synergistic effect, which substantially enhances the hydrotreating activity and improves the Cn-1 paraffin selectivity. Some catalysts, such as RuNi/CeO₂—ZrO₂ catalyst, additionally may avoid the formation of undesirable C2n compounds still containing nitrogen, i.e. condensation products formed during the reaction, such as secondary amines or amides. The redox-active CeO₂—ZrO₂ support considerably contributes to the catalytic activity and enables keeping the active metal loadings lower compared to conventional, non-redox active supports.

According to an embodiment, RuNi/CeO₂—ZrO₂ and PtNi/CeO₂—ZrO₂ catalysts are preferred, as they are believed to display exceptional activity in simultaneous HDN and HDO.

The catalyst can also comprise three active metals on a support capable of undergoing reversible redox reactions during the production of the paraffinic hydrocarbons, and the catalyst is sulfided prior to use. One example of such a catalyst is NiMoW on any support discussed here.

It was observed that the ruthenium-containing catalysts produce the Cn-1 normal paraffin with a high selectivity and form significantly less heavy C2n compounds compared to the other catalysts on the same support, prepared with the same method and the same nominal active metal loading.

According to an embodiment, the catalyst is selected from a group consisting of Pt/Nb₂O₅, Pt/CeO₂—ZrO₂, Ru/Nb₂O₅, Ru/CeO₂—ZrO₂, Ni/Nb₂O₅Ni/CeO₂—ZrO₂, RuNi/CeO₂—ZrO₂, PtNi/CeO₂—ZrO₂, PtNi/Nb₂O₅, and RuNi/Nb₂O₅.

According to another embodiment, the catalyst is selected from a group consisting of NiMo/CeO₂—ZrO₂, NiMo/Nb₂O₅, CoMo/CeO₂—ZrO₂, CoMo/Nb₂O₅, NiW/CeO₂—ZrO₂ and NiW/Nb₂O₅. According to yet another embodiment, the catalyst is selected from a group consisting of NiMoW/CeO₂—ZrO₂, NiMoW/Nb₂O₅, Ni/CeO₂—ZrO₂ and CoMoW/Nb₂O₅, with NiMoW/CeO₂—ZrO₂ being preferred. Indeed, it is believed that nickel is optimal for the hydrogenation, and CeO₂—ZrO₂ as a support was found to give the best results.

The catalysts may be sulfided before their use. In one embodiment when using the NiMo, NiW, CoMo, NiMoW based catalysts the catalyst needs to be sulfided. The sulfidation may take place before the conversion reaction. Typically, the catalysts are sulfided before taking them into use. For example, the metal (such as Ni, Co, Mo or W, typically Ni and Co are not used alone) are typically first in the form of calcined oxides, which are sulfided using a hydrogen flow that contains sulfur-containing compound(s). In one embodiment the NiMo, NiW, NiMoW based catalysts may be sulfided in situ by using a sulfur-containing compound directed simultaneously with the feed to the reactor.

According to an embodiment, the active metal loading, i.e. the amount of active metal on the support, is 0.1-25 wt-% of the total weight of the catalyst, as elemental metal. The amount of active metal can be for example 0.5-10 wt-%, such as 1-10 wt-%. The amount can, thus, be for example from 0.1, 0.5, 1, 2, 5, 8, 10, 13, 15, 17, 20, 22 or 24 wt-% up to 0.5, 1, 2, 5, 8, 10, 13, 15, 17, 20, 22, 24 or 25 wt-%. The choice of the active metal loading depends on the aimed balance between loading and dispersion, meaning that a too high or too low active metal loading decreases the number of active sites. It is believed that the present catalysts can be either recycled or the support used can be recycled. Further, it is believed that at least most of renewable feedstocks would not contain any catalyst deactivators or poisons, that could either not be removed by a suitable pre-treatment method, or that would be present in such a small amount that catalyst deactivation or poisoning is not an issue within a reasonable time.

According to an embodiment, the feedstock comprises oxygen and nitrogen atoms in the same molecule. According to another embodiment, the feedstock comprises molecules having oxygen atoms and molecules having nitrogen atoms. The compounds can also be intermediates in the reaction pathways to oxygen and nitrogen free products (products having oxygen and nitrogen content below 10 ppm).

Renewable feedstock can be any kind of animal, plant or fish-based material containing oxygen. The oxygen in the feedstock may originate from, for example, triglycerides and/or free fatty acids of the feedstock material.

In one embodiment, the renewable feedstock of the present disclosure contains triglycerides, free fatty acids, carboxylic acids, or one or more of these.

More specifically, in one embodiment, the feedstock is selected from the group consisting of:
plant fats, plant oils, plant waxes; animal fats, animal oils, animal waxes; fish fats, fish oils, fish waxes;
fatty acids, bound or free fatty acids obtained from plant fats, plant oils, plant waxes, animal fats, animal oils, animal waxes, fish fats, fish oils, fish waxes, and mixtures thereof by, e.g., hydrolysis, transesterification or pyrolysis;
esters obtained from plant fats, plant oils, plant waxes; animal fats, animal oils, animal waxes; fish fats, fish oils, fish waxes; and mixtures thereof by, e.g., transesterification;
metal salts of fatty acids obtained from plant fats, plant oils, plant waxes; animal fats, animal oils, animal waxes; fish fats, fish oils, fish waxes, and mixtures thereof by, e.g., saponification;
esters obtained by esterification of free fatty acids of plant, animal and fish origin with, e.g., alcohols;
fatty alcohols or aldehydes obtained as reduction products of fatty acids from plant fats, plant oils, plant waxes; animal fats, animal oils, animal waxes; fish fats, fish oils, fish waxes, and mixtures thereof;
waste and residues, such as recycled food grade fats and oils and sludges originating from plant oil production;
fats, oils and waxes obtained by genetic engineering;
dicarboxylic acids or polyols including diols, hydroxyketones, hydroxyaldehydes, hydroxycarboxylic acids, and corresponding di- or multifunctional sulfur-containing compounds, corresponding di- or multifunctional nitrogen-containing compounds;
bio-based pyrolysis oils, such as pyrolysis oil from wood;
compounds derived from microbes, algae or wood; and
mixtures of any of the materials listed herein.

In an embodiment, the feedstock is based on a non-edible oil or fat. In another embodiment, the feedstock comprises plant oil. In a further embodiment, the plant oil is obtained as wood-based by-product materials from the forest industry. The renewable feedstocks can also be characterised as biomass based oils and waxes.

The feedstock can also be a recycled feedstock, originating either from renewable sources or from fossil sources. According to a particular embodiment, the feedstock is selected from different wastes and residues, as well as liquefied waste plastics (LWP), or originated from municipal solid waste. Such feedstocks are currently considered as low quality feedstocks, due to the high amounts of impurities they contain, making them challenging raw materials for production of paraffinic hydrocarbons.

The impurities in the feedstocks can be for example metals, phosphorus, silicon, inorganic salts, polymers, silicon dioxide, halides, etc. The low quality feedstocks may also have a high acidity.

According to yet another embodiment, the feedstock can also be synthetic hydrocarbons. The synthetic hydrocarbons can be from renewable or fossil origin, or of recycled origin.

According to an embodiment, the feedstock comprises triglycerides. According to another embodiment, the feedstock comprises at least fatty acids, free fatty acids or bound fatty acids, such as saponified fatty acids found in tall oil (crude tall oil and products derived from it).

According to a preferred embodiment, the feedstock comprises wood based oils such as crude tall oil (CTO), tall oil pitch (TOP), tall oil fatty acid (TOFA), crude fatty acid (CFA), distilled tall oil (DTO); acid oils such as acidulated soapstock; technical corn oil (TCO); plant oil from plants of the family Brassicaceae; palm effluent sludge (PES); used cooking oil (UCO); gutter oil; brown grease (BG); algae; and any combination thereof.

According to another embodiment, animal fats and/or oils and greases may include inedible tallow, edible tallow, technical tallow, floatation tallow, lard, poultry fat, dry rendered poultry fat, poultry oils, fish fat, fish oils, crude palm oil (CPO), palm oil, palm seed oil, palm fatty acid distillate (PFAD), palm oil mill effluent (POME), babassu oil, coconut butter, muscat butter oil, sesame oil, maize oil, poppy seed oil, cottonseed oil, soy oil, laurel seed oil, jatropha oil, palm kernel oil, camelina oil, archaeal oil, bacterial oil, fungal oil, protozoal oil, algal oil, seaweed oil, mustard seed oil, oils from halophiles, soybean oil (SB), rapeseed oil (RSO), colza oil, canola oil, sunflower oil, hemp seed oil, olive oil, linseed oil, mustard oil, peanut oil, castor oil, coconut oil, lard, tallow, train oil, spent bleaching earth oil (SBEO), lignocellulosic based feeds, yellow grease, brown grease, waste vegetable oils, restaurant greases, trap grease from municipalities such as water treatment facilities, and spent oils from industrial packaged food operations, pyrolysis oils, and mixtures of any two or more thereof.

The natural fats and oils or derivatives thereof may be provided in pure form or as part of a feedstock containing other components. Preferably, the feedstock contains at least 20 wt-%, more preferably at least 30 wt-%, most preferably at least 40 wt-%, of the natural fat or natural oil or their derivatives (calculated as pure).

The oils of the feedstock may be classified as crude, degummed, heat treated and RBD (refined, bleached and deodorised) grade, depending on the level of pre-treatment and residual phosphorus and metals content.

Typical nitrogen impurity ranges (wt-ppm) in different organic materials are for example 100-500 ppm for CTO, 100-1500 ppm for TOP, 30-500 ppm for PES, 1-600 ppm for UCO, 50-5000 ppm for BG, 20-100 ppm for TCO, 30-100 ppm for BC and 1-3000 ppm for AF.

The pre-treatment may be a heat treatment (HT) optionally followed by evaporation of volatiles, or a heat treatment with adsorbent (HTA) optionally followed by flash evaporation. Heat treatment can also be followed by filtration as an addition or an alternative to evaporation. An example of HT can be found in WO 2020/016405, and an example of HTA can be found in WO 2020/016410. The pre-treatment may also be a bleaching, for example with an acid, followed by filtration, or acid degumming followed by solid removal from the liquid, using filtration of centrifugation. Further possible pre-treatment steps are for example removal of solids (using technologies such as centrifugation or filtration), water washing, hydrolysis, or distillation. Any combination of the pre-treatments may be used, in any order.

According to an embodiment, the production of the paraffinic hydrocarbons comprises hydrotreatment, preferably hydrogenolysis, hydrodeoxygenation, hydrodenitrogenation, hydrodearomatisation, hydrodesulfurisation, hydroisomerisation, hydrocracking, and combinations thereof. The method may comprise more than one stage, and more than one catalyst can be used. The present catalysts can be used in any kind of hydrotreatment to lower the oxygen and nitrogen content of the feedstock.

The production of the paraffinic hydrocarbons may be for example carried out by pre-treating the feedstock; subjecting the pre-treated feedstock to hydrotreatment using the catalyst comprising at least one active metal and a support capable of undergoing reversible redox reactions; and hydroisomerising the hydrotreated feedstock to obtain the paraffinic hydrocarbons. The hydrotreatment mainly converts the feedstock into n-paraffins, which are then mainly converted to i-paraffins or branched paraffins in the hydroisomerisation.

After pre-treatment, the pre-treated feedstock typically has impurity levels common in the field of hydrotreatment of renewable feedstocks, such as less than 500 ppm for nitrogen.

Sulfided catalysts typically can handle higher amounts of nitrogen than noble metal catalysts. In addition to the catalyst, the hydrotreatment conditions, such as temperature, residence time and pressure have an impact on the acceptable impurity level of the feedstock entering the hydrotreatment. A clear advantage of the present catalysts is that they are capable of lowering the amount of nitrogen and oxygen, which usually require use of two different catalysts, one efficient for removing nitrogen, the other efficient for removing oxygen.

According to an embodiment, the reaction is carried out at a temperature of 200 to 500° C., a pressure of 1 to 20 MPa, and a hydrogen flow of 100 to 1500 NI H₂/l feed. The pressure can be for example from 2 to 15 MPa, or even from 3 to 10 MPa. The expression NI H₂/I means normal litres of hydrogen per litre of the feed into the reactor. According to one particular embodiment, the reaction conditions comprise a temperature in the range from 250 to 400° C., a pressure in the range from 2 to 12 MPa, a WHSV (weight hourly space velocity) in the range from 0.5-3 h⁻¹, and hydrogen flow of 350-900 NI H₂/l feed, and the present catalyst.

In another embodiment, hydrogenolysis is applied at a temperature from 270 to 450° C. and at a pressure from 10 to 100 bar.

According to an embodiment, said hydrotreatment comprises hydrodeoxygenation and isomerisation, wherein a temperature in the range from 250 to 400° C., a pressure in the range from 1 to 2 MPa and a hydrogen flow in the range from 350 to 1500 NI H₂/l feed are used.

According to another particular embodiment, the hydrodeoxygenation reaction conditions comprise temperature in the range from 250 to 400° C., pressure in the range from 2 to 8 MPa, a WHSV (weight hourly space velocity) in the range from 0.5-3 h⁻¹, and hydrogen flow of 350-900 NI H₂/I feed, and a hydrodeoxygenation catalyst.

The hydrotreatment may be performed at a temperature from 270 to 380° C., such as from 275 to 360° C., or from 300 to 350° C. The temperature may be for example from 250, 255, 260, 265, 270, 275, 280, 285, 290, 295, 300, 305, 310, 315, 320, 325, 330, 335, 340, 345, 350, 355, 360, 365, 370, 375, 380 or 385° C. up to 265, 270, 275, 280, 285, 290, 295, 300, 305, 310, 315, 320, 325, 330, 335, 340, 345, 350, 355, 360, 365, 370, 375, 380, 385, 390, 395 or 400° C. The pressure during hydrotreatment may be from 4 to 20 MPa. The pressure can be for example from 1, 2, 3, 4, 5, 6, 7, 8, 9, 10, 11, 12, 13, 14, 15, 16, 17 or 18 MPa up to 3, 4, 5, 6, 7, 8, 9, 10, 11, 12, 13, 14, 15, 16, 17, 18, 19 or 20 MPa.

According to an embodiment, and in particular in the case of HDO, the weight hourly space velocity (WHSV) used is in the range from 0.25 to 3.0 h⁻¹, preferably from 0.7 to 3.0 h⁻¹, more preferably from 1.0 to 2.5 h⁻¹, most preferably from 1.0 to 2.0 h⁻¹, depending on the hydrogen consumption. The hydrogen gas flow, especially for HDO, may be in the range from 350 to 1500 NI H₂/l feed, more preferably from 350 to 900 NI H₂/I feed, most preferably from 350 to 750 NI H₂/l feed, such as from 350 to 500 NI H₂/l feed.

Isomerisation can be carried out in a conventional hydroisomerisation unit, such as those depicted in FI 100248, EP 1741768, WO 2007/068795, WO 2016/062868 or EP 2155838. Hydrogen is added into the hydroisomerisation step.

The isomerisation step can be performed at a temperature from 250 to 400° C., such as from 280 to 370° C., or from 300 to 350° C. Pressure may be from 1 to 6 MPa, or from 2 to 5 MPa, or from 2.5 to 4.5 MPa. The WHSV may be from 0.5 to 3 l/h, such as from 0.5 to 2 l/h, or from 0.5 to 1 l/h, and H₂ flow may be from 100 to 800 NI H₂/I feed, or from 200 to 650, or even from 350 to 500 NI H₂/l feed.

During isomerisation n-paraffins are branched, i.e. forming i-paraffins. Preferably, the conditions are chosen such that the branches are located at or near the terminal ends of the molecules, and therefore the cold flow properties of renewable fuels are improved. The presently obtained products may naturally also be used for other purposes than for renewable fuels, and the present catalysts used for the manufacturing of other paraffinic hydrocarbons than fuels.

The isomerisation treatment is a step which predominantly serves to isomerise the hydrotreated raw material. That is, while most thermal or catalytic conversions (such as HDO) result in a minor degree of isomerisation (usually less than 5 wt-%), the isomerisation step which may be employed in the present process is a step which leads to a significant increase in the content of iso-paraffins.

The present description also relates to use of a catalyst comprising at least one active metal and a support capable of undergoing reversible redox reactions for simultaneously lowering oxygen and nitrogen content in a renewable and/or recycled feedstock, the support being selected from a group consisting of cerium dioxide, cerium dioxide-zirconium dioxide, cerium dioxide-alumina, cerium dioxide-silica, niobium pentoxide, niobium pentoxide-zirconium dioxide, niobium pentoxide-alumina, niobium pentoxide-silica and mixtures of at least two of cerium dioxide-zirconium dioxide, niobium pentoxide, and titanium dioxide.

The different embodiments and variants mentioned above apply mutatis mutandis to the use. The use may be for production of paraffinic hydrocarbons, wherein the production comprises a hydrotreatment step, preferably hydrodeoxygenation, hydrodenitrogenation, hydrogenolysis, and/or hydropolishing. The catalyst may be used for a process of producing hydrocarbons, or as an additional purification process, such as a hydropolishing, preferably after a conventional hydrotreatment process.

In an embodiment, the present catalyst is used for hydropolishing, preferably in hydropolishing after hydrodeoxygenation. Before hydropolishing, any sour gases (such as ammonia, water and hydrogen sulphide) are preferably removed, for example by a stripper.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Furthermore, the described features, structures, or characteristics may be combined in any suitable manner in one or more embodiments. In the description, numerous specific details are provided to provide a thorough understanding of embodiments of the invention.

The verbs “to comprise” and “to include” are used in this document as open limitations that neither exclude nor require the existence of also un-recited features. The features recited in dependent claims are mutually freely combinable unless otherwise explicitly stated. Furthermore, it is to be understood that the use of “a” or “an”, i.e. a singular form, throughout this document does not exclude a plurality.

### Experimental Part

Experiments were carried out in order to test the present catalysts. It is to be noted that in the tests, the conditions were selected such that a comparison between the different catalysts was possible. The tests do, thus, not present optimised process conditions.

Compounds containing organic amine and amide groups were selected to represent the species in the feedstock having only a nitrogen heteroatom in the alkyl chain bound to carbon and having both a nitrogen and an oxygen heteroatom in the alkyl chain bound to carbon, respectively. The model compounds represent well the nitrogen- and oxygen-containing compounds found in renewable feedstocks, such as plant oils and animal fats, and in waste and residue materials, such as used cooking oil and liquefied waste plastics.

Different catalysts according to the invention were thus evaluated in the simultaneous nitrogen and oxygen removal from hexadecanamide (C₁₆H₃₃NO) as well as for nitrogen removal from hexadecylamine (C₁₆H₃₅N).

### Materials Used

Commercially available metal precursors used for impregnation were platinum (IV) nitrate solution (Pt dissolved in nitric acid, Pt 15 wt/wt), ruthenium (III) nitrosyl nitrate (Ru(NO)NO₃)₃, Ru 31.78 wt/wt), nickel (II) nitrate hexahydrate (Ni(NO₃)₂*6 H₂O), ammonium molybdate tetrahydrate ((NH₄)₆MO₇O₂₄*4H₂O), and cobalt (II) nitrate hexahydrate (Co(NO₃)₂*·6 H₂O).

The ZrO₂ support, the γ-Al₂O₃ support, the 17CeO₂—ZrO₂ support (17 wt-% CeO₂/83 wt-% ZrO₂), the 25CeO₂—ZrO₂ support (25 wt-% CeO_{2/75} wt-% ZrO₂), the Nb₂O₅ support were obtained from commercial support vendors.

Citric acid was further used in the preparation of some catalysts.

### Preparation of the Supports

All supports were crushed if needed, then sieved to a particle size of 0.25-0.42 mm. The supports were calcined in a static muffle furnace for 10 hours prior to impregnation, in order to remove water and other potential impurities. A heating rate of 10° C./min was used for all supports.

The 17CeO₂—ZrO₂, and 25CeO₂—ZrO₂ supports were calcined at 450° C., while the ZrO₂ and γ-Al₂O₃ were calcined at 600° C. for use in Comparative examples 1-4, and at 500° C. for use in Comparative example 5. The Nb₂O₅ support was calcined at 500° C., pelletised before sieving and re-calcined at 250° C. before the impregnation. The calcination temperatures were chosen according to the stability of the material used.

### Preparation of the Catalysts

### Example 1 (E1)

A Pt/Nb₂O₅ catalyst was prepared with a regular vacuum impregnation method, targeting a 1 wt-% platinum loading.

Approximately 2.5 grams of calcined Nb₂O₅ support was placed in a 100 ml round-bottom flask, and further dried under vacuum at 70° C. for 90 minutes. An aqueous platinum nitrate solution was prepared by mixing platinum (IV) nitrate with ultrapure water. The amount of platinum nitrate used corresponded to a 1 wt-% nominal platinum loading, whereas the amount of water matched approximately 2.5 times the support pore volume. The solution was poured to a dropping funnel, which was connected through a tube to the round bottom flask.

Calcination of the obtained product was carried out in a synthetic air (100 ml/min) in a flow-through calcination oven at 450° C., heating rate of 2° C./min. The temperature was maintained at 450° C. for 1 hour, after which the heating was switched off and the sample was allowed to cool down in the air flow.

### Example 2 (E2)

Example 1 was repeated to prepare a Pt/25CeO₂—ZrO₂ catalyst, by using 25CeO₂—ZrO₂ as support.

### Example 3 (E3)

A Ru/17CeO₂—ZrO₂ catalyst was prepared with commonly used incipient wetness impregnation (IWI) technique, targeting a 0.5 wt-% ruthenium loading.

The active metal precursor solutions were prepared with ultrapure water to match the pore volume of the support. The impregnation solution was introduced dropwise to the support, stirring vigorously between the additions. The catalysts were aged at room temperature overnight and dried in an oven for 5 hours at 120° C.

Calcination of the obtained product was carried out in a synthetic air (100 ml/min) in a flow-through calcination oven, by raising the temperature to 450° C. with a heating rate of 1° C./min. The temperature was maintained at 450° C. for 2 hours, after which the heating was switched off and the sample was allowed to cool down in the air flow.

### Example 4 (E4)

Example 3 was repeated to prepare a Ni/17CeO₂—ZrO₂ catalyst, by using nickel instead of ruthenium, and targeting 1 wt-% nickel loading.

### Example 5 (E5)

Example 3 was repeated to prepare a Ni/17CeO₂—ZrO₂ catalyst, targeting 1.5 wt-% nickel loading.

### Example 6 (E6)

Example 3 was repeated to prepare a Ni/17CeO₂—ZrO₂ catalyst, targeting 5 wt-% nickel loading.

### Example 7 (E7)

Example 3 was repeated to prepare a Ni/17CeO₂—ZrO₂ catalyst, targeting 10 wt-% nickel loading.

### Example 8 (E8)

Example 3 was repeated to prepare a Pt/17CeO₂—ZrO₂ catalyst, targeting 0.5 wt-% platinum loading.

### Example 9 (E9)

Example 3 was repeated to prepare a Co/17CeO₂—ZrO₂ catalyst, targeting 1.5 wt-% cobalt loading.

### Example 10 (E10)

Example 3 was repeated to prepare a RuNi/17CeO₂—ZrO₂ catalyst, targeting 0.5 wt-% ruthenium loading and 1.5 wt-% nickel loading. Both active metals were impregnated together.

### Example 11 (E11)

Example 3 was repeated to prepare a PtNi/17CeO₂—ZrO₂ catalyst, targeting 0.5 wt-% platinum loading and 1.5 wt-% nickel loading. Both active metals were impregnated together.

### Example 12 (E12)

Example 3 was repeated to prepare a PtCo/17CeO₂—ZrO₂ catalyst, targeting 0.5 wt-% platinum loading and 1.5 wt-% cobalt loading. Both active metals were impregnated together.

### Example 13 (E13)

A NiMo/17CeO₂—ZrO₂ catalyst was prepared by incipient wetness co-impregnation method, targeting 1.5 wt-% nickel loading and 6.5 wt-% molybdenum loading. Citric acid (CA) was used as an additive.

The targeted amount of ammonium molybdate tetrahydrate (AHM) was first dissolved in MILLIQ water. The amount of water was chosen to match the pore volume of the support that was to be impregnated. The water was heated on a hot plate to allow AHM to dissolve quicker. Once AHM had dissolved, the mass of the water was re-measured and a few drops were added to compensate for evaporation if needed. After complete dissolution of AHM, citric acid (CA) was dissolved in the mixture, followed by nickel nitrate. The molar ratio of Ni/CA was kept constant at 1.6. The support, dried overnight at 120° C., was next impregnated at ambient temperature with the liquid solution under constant stirring. The impregnated solid was allowed to age overnight, and it was then dried for 4 hours at 120° C. The dried catalyst precursors were then calcined at 500° C. for 2 h with a temperature ramp of 2° C./min and constant flow of synthetic air (100 ml/min). Finally, the obtained oxidic precursor was sieved to the desired particle size and then sulfided by drying at 180° C. (10° C./min) for 60 minutes under 10 bar N₂ flow and sulfided under 10 bar 10 vol-% H₂S/H₂ at 120-400° C. (2° C./min), with a 120 minutes hold at 400° C., under 200 rpm stirring.

### Example 14 (E14)

Example 3 was repeated to prepare a Ni/17CeO₂—ZrO₂ catalyst, targeting 0.5 wt-% nickel loading.

### Comparative Example 1 (CE1)

Example 1 was repeated to prepare a Pt/γ-Al₂O₃ catalyst, by using γ-Al₂O₃ as support, to compare the catalyst of Example 1 to a known catalyst.

### Comparative Example 2 (CE2)

Example 1 was repeated to prepare a Pt/ZrO₂ catalyst, by using ZrO₂ as support, to compare the catalyst of Example 1 to a known catalyst.

### Comparative Example 3 (CE3)

A Ru/ZrO₂ catalyst was prepared by vacuum impregnation method, to compare the catalyst of Example 4 to a known catalyst. The target was a 1 wt-% ruthenium loading.

Approximately 2.5 grams of calcined ZrO₂ support was placed in a 100 ml round-bottom flask, and further dried in a rotavapor under vacuum at 60° C. for 90 minutes. An aqueous metal solution was prepared with ultrapure water. The amount of ruthenium used corresponded to a 1 wt-% nominal loading, whereas the amount of water matched approximately 4 times the support pore volume. The support was allowed to cool down, before the precursor solution was introduced dropwise, without breaking the vacuum. The flask was stirred at 120 rpm under vacuum for 2 hours without heating, allowing the excess liquid to slowly evaporate. The catalyst was under vacuum in the rotavapor the next day, first at 40° C. for 60 minutes and then at 60° C. for 30 minutes.

Calcination of the obtained product was carried out in a synthetic air in a flow-through calcination oven, by raising the temperature to 450° C. with a heating rate of 1° C. per minute. The temperature was maintained at 450° C. for 2 hours, after which the heating was switched off and the sample was allowed to cool down in the air flow. The flow rate of synthetic air was maintained at 100 ml/min throughout the calcination.

### Comparative Example 4 (CE4)

Comparative example 3 was repeated to prepare a Ni/ZrO₂ catalyst, targeting a 1 wt-% nickel loading, to compare to the catalyst of Example 5.

### Comparative Example 5 (CE5)

The performance of a NiMo/γ-Al₂O₃ catalyst was also compared to NiMo/17CeO₂—ZrO₂ (Example 12) catalyst. The catalyst was prepared as in Example 14, using γ-Al₂O₃ as support instead of 17CeO₂—ZrO₂.

The activity tests of the sulfided catalyst were carried out in a 100 ml stainless steel batch reactor, at 300° C., 70 bar H₂ with 20 or 40 mg of catalyst and one hour reaction time.

The reactant mixture was 54.7 mg of hexadecanamide in 30 ml of decalin (100 ppm initial nitrogen content).

### Characterisation of the Catalysts

Some of the catalysts were characterised to determine semi-quantitative platinum loadings, which were considered to provide reasonable comparative values. This was done by using X-ray fluorescence (XRF, commercial wavelength dispersive PANalytical Axios mAx equipment), mean (platinum) particle size estimated from TEM images (dPt, TEM, commercial JEOL JEM-220FS high resolution electron microscope with 200 kV acceleration voltage), specific surface area (SBET, Surfer equipment by Thermo Scientific), pore volume (Vpore) and mean pore diameter (dpore) of the catalysts measured according to by a commercial volumetric gas adsorption instrument according to ASTM D3663-20. All measurements were made for the calcined catalysts. The results are given in Table 1.

TABLE 1

| | Active metal | dPt | | | |
|---|---|---|---|---|---|
| | loading, XRF | (TEM) | SBET | Vpore | dpore |
| Catalyst | (wt-%) | (nm) | (m²/g) | (cm³/g) | (nm) |
| E1 Pt/Nb₂O₅ | 0.8 | 2.0 | 73 | 0.13 | 6 |
| E2 Pt/ | 0.8 | 1.6 | 70 | 0.24 | 14 |
| 25CeO₂—ZrO₂ | | | | | |
| CE1 Pt/γ-Al₂O₃ | 0.7 | 1.9 | 143 | 0.39 | 10 |
| CE2 Pt/ZrO₂ | 0.6 | 2.2 | 42 | 0.21 | 18 |
| CE3 Ru/ZrO₂ | 0.7 | — | 47 | 0.21 | 20 |

Some further catalysts were characterised to determine their acidity and basicity. The acidity of the catalysts was measured through transmission Fourier transform infrared spectroscopy (FTIR) measurements of pyridine adsorption. The samples were pre-treated by heating under vacuum to 450° C., where they were held for 60 minutes, and cooled down to 170° C., where a spectra of the clean sample was recorded. The samples were saturated with pyridine at 170° C., which was followed by a 15 minute flush, before the spectra that was used to quantify the acidity was recorded. The clean spectra was subtracted from the pyridine-saturated spectra, and a baseline correction was carried out.

The amount of Lewis and Brønsted acid sites was semi-quantitatively estimated correlating the integrated peak areas with the sample weight and sample diameter, using an empirical equation presented in C. A. Emeis, Journal of Catalysis 141 (1993) 347-354. The results are presented in Table 2.

TABLE 2

| | Lewis | Lewis | Brønsted | Brønsted | Total | Total |
|---|---|---|---|---|---|---|
| | acidity | acidity | acidity | acidity | acidity | acidity |
| Catalyst | (μmol/g) | (μmol/m²) | (μmol/g) | (μmol/m²) | (μmol/g) | (μmol/m²) |
| E1 Pt/Nb₂O₅ | 207 | 2.8 | 93 | 1.3 | 300 | 4.1 |
| E2 | 242 | 3.4 | 4 | 0.1 | 250 | 3.5 |
| Pt/25CeO₂—ZrO₂ | | | | | | |
| CE1 Pt/γ- | 253 | 1.8 | 5 | <0.1 | 260 | 1.8 |
| Al₂O₃ | | | | | | |
| CE2 Pt/ZrO₂ | 31 | 0.7 | 2 | 0.1 | 30 | 0.8 |

The Pt/25CeO₂—ZrO₂ catalyst had the highest Lewis acid site concentration, and the acid sites were weaker compared to the other catalysts.

The overall basicity of the catalysts was measured with temperature programmed desorption of CO₂ (CO₂-TPD). The samples were dried at 180° C. for 2 hours in helium, and reduced at 350° C. for 2 hours, before saturation with CO₂ at 50° C. for 30 minutes. After saturation, the samples were flushed for 60 minutes, and heated to 600° C. in helium flow with a heating rate of 10° C./min. The desorbed amount of CO₂ was quantified with a mass spectrometer (MS), following m/z 44. The overall basicity of the catalysts, calculated based on the desorbed amount of CO₂ is displayed in Table 3.

TABLE 3

| | Desorbed | Desorbed |
|---|---|---|
| Catalyst | CO₂ (μmol/g) | CO₂ (μmol/m²) |
| E1 Pt/Nb₂O₅ | 2 | <0.1 |
| E2 Pt/25CeO₂—ZrO₂ | 210 | 3.0 |
| CE1 Pt/γ-Al₂O₃ | 26 | 0.2 |
| CE2 Pt/ZrO₂ | 42 | 0.8 |

The Pt/25CeO₂—ZrO₂ had the highest concentration of basic sites and the basic sites were stronger compared to the other catalysts. In addition, it exhibits the highest Lewis acidity concentration.

The Pt/25CeO₂—ZrO₂ catalyst therefore displayed an acid-base bi-functionality. The Pt/Nb₂O₅ displayed lower basicity.

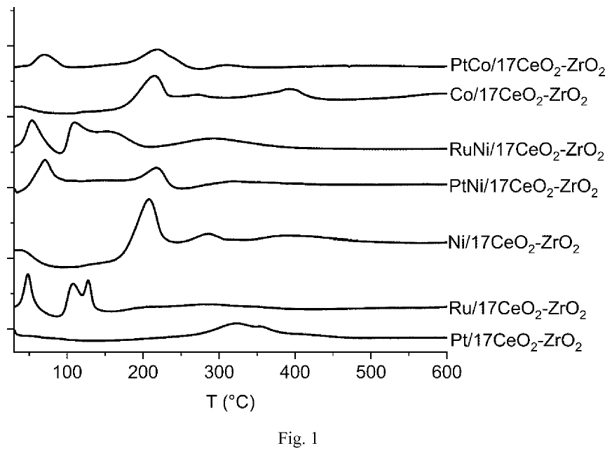

Temperature programmed reduction (TPR) was carried out for selected catalysts to qualitatively study the reducible species present on the catalyst surface. The samples were first dried at 200° C. in helium for 2 h, and then cooled down to 30° C. in argon. A 50 ml/min (STP) flow of 2% H₂/Ar was then directed through the samples, while the temperature was elevated from 30° C. to 600° C. (5° C./min). FIG. 1 displays the TPR profiles of the tested catalysts, i.e. the H₂ consumption (arbitrary units). The catalysts from top to bottom are those of Example 12, Example 9, Example 10, Example 11, Example 5, Example 3 and Example 8.

For the platinum monometallic catalysts, peaks related to reduction of the supports were pronounced for Pt/17CeO₂—ZrO₂. For the other catalysts on the 17CeO₂—ZrO₂ support, peaks related to reduction of the support were observed for some catalysts. For the bimetallic catalysts, the noble metal enhanced the reducibility of the transition metal (Ni, Co), as observed from shifts in the reduction temperature.

X-ray photoelectron spectroscopy (XPS) measurements were done to study the chemical state of the catalyst surface for some samples. Before the measurements, all samples were reduced ex-situ in H₂ at 350° C. for 60 minutes and transferred to the equipment exposed to atmosphere. The measurements were performed with a Kratos AXIS Ultra DLD X-ray photoelectron spectrometer using a monochromated AlKα X-ray source (1486.7 eV) run at 100 W. A pass energy of 80 eV and a step size of 1.0 eV were used to record survey spectra, while a pass energy of 20 eV and a step size of 0.1 eV were used to record the high-resolution spectra. Photoelectrons were collected at a 90° take-off angle under ultra-high vacuum conditions, with a base pressure typically below 1×10−9 Torr. The diameter of the beam spot from the X-ray was 1 mm, and the area of analysis for these measurements was 300 μm×700 μm. Both survey and high-resolution spectra were collected from three different spots on each sample. All spectra were charge-corrected relative to the position of C—C bonding of carbon at 284.8 eV. After the measurement, the spectra were deconvoluted.

Table 4 displays the atomic surface composition of the catalysts, obtained from the XPS measurements. The surface concentration of Pt varied between 3.2 and 5.0 at. %. The Pt was therefore enriched on the catalyst surface.

TABLE 4

| | Pt | O | C | | Zr | Ce | Nb | |
|---|---|---|---|---|---|---|---|---|
| | 4f/4d | 1s | 1s | Al | 3d | 3d | 3d | F |
| Catalyst | (at. %) | (at. %) | (at. %) | (at. %) | (at. %) | (at. %) | (at. %) | (at. %) |
| E1, | 4.5 | 55.1 | 13.8 | — | — | — | 26.7 | — |
| Pt/Nb₂O₅ | | | | | | | | |
| E2 | 3.9 | 53.1 | 14.1 | — | 25.3 | 3.7 | — | — |
| Pt/25CeO₂—ZrO₂ | | | | | | | | |
| E14, 0.5 | 5.0 | 50.4 | 13.0 | — | 27.4 | 2.7 | — | 1.5 |
| wt-% | | | | | | | | |
| Pt/17CeO₂—ZrO₂ | | | | | | | | |
| CE1, Pt/γ- | 5.9 | 49.4 | 9.3 | 35.5 | — | — | — | — |
| Al₂O₃ | | | | | | | | |
| CE2, | 4.9 | 52.3 | 12.5 | — | 30.4 | — | — | — |
| Pt/ZrO₂ | | | | | | | | |

Table 5 presents the relative shares of the different oxidation states of Pt, as well as the binding energy for the Pt (0) component of Pt 4f7/2 and for the lattice O component of O 1s. As can be seen from Table 5, the oxidation state of Pt was similar for all catalysts, with the majority of the platinum (69-82%) in the form of metallic Pt (0). Pt (I) and the mixed state (between I and II) were the second most prevalent oxidation states for all catalysts. Less than 8% of the Pt was found in each of the higher oxidation states (II, IV) on all supported Pt catalysts.

TABLE 5

| | | | | | | Binding energy | |
|---|---|---|---|---|---|---|---|
| | Oxidation states of Pt | | | | | | Lattice |
| | Pt(0) | Pt(I) | Pt(mix) | Pt(II) | Pt(IV) | Pt(0) | O^{b} |
| Catalyst | (%) | (%) | (%) | (%) | (%) | (eV) | (eV) |
| E1, Pt/Nb₂O₅ | 77% | 12% | 2% | 6% | 3% | 71.2 | 530.3 |
| E2, Pt/ | 72% | 17% | 2% | 6% | 3% | 70.9 | 529.6 |
| 25CeO₂—ZrO₂ | | | | | | | |
| E14, 0.5 wt-% | 75% | 2% | 12% | 2% | 8% | 70.8 | 529.4 |
| Pt/ | | | | | | | |
| 17CeO₂—ZrO₂ | | | | | | | |
| CE1, Pt/γ- | 69% | 4% | 15% | 6% | 6% | 70.8 | 531.5 |
| Al₂O₃ | | | | | | | |
| CE2, Pt/ZrO₂ | 72% | 16% | 3% | 5% | 4% | 70.9 | 530.0 |

Out of the Ce atoms on the surface of Pt/25CeO₂—ZrO₂ (E2), 38.5% were found as Ce (III) and 61.5% in Ce (IV). On Pt/17CeO₂—ZrO₂ (E14), 50.6% of the surface Ce atoms were present as Ce (III), and 49.4% as Ce (IV). It can thus be concluded that the reduction of CeO₂ readily occurred on both of the CeO₂—ZrO₂ supports (Table 5).

XPS results of the monometallic and bimetallic catalysts supported on 17CeO₂—ZrO₂ are presented in Table 6, where conc. stands for concentration, nom. stands for nominal, and Zrₘᵢₓ stands for Zr_{mixed}. The Table contains the active metal surface concentration, atomic ratio of the active metals calculated from the surface composition and from the nominal loadings, the atomic ratio of active metal to the total amount of Ce and Zr on the catalyst surface, the relative amount of the active metals in the reduced state, the amounts of cerium as Ce³⁺ and Zr in the mixed higher binding energy state relative to the total amount of Ce and Zr, respectively, and the share of surface O as OH species.

TABLE 6

| | Surface | | | | M₁ (0), | | | |
|---|---|---|---|---|---|---|---|---|
| | conc. of | M₁/M₂ | M₁/M₂ | | (%) | Ce³⁺/ | Zrₘᵢₓ/ | OH/ |
| | M₁ and M₂ | ratio, | ratio, | (M₁ + M₂)/ | M₂ (0), | Ce, tot | Zr, tot | Oₜₒₜ |
| | (at. %) | XPS | nom. | (Ce + Zr) | (%) | (%) | (%) | (%) |
| 17CeO₂—ZrO₂alone | — | — | — | — | — | 37 | 15 | 22 |
| E3, Ru | 1.2 | — | — | 0.04 | 30 (Ru) | 40 | 14 | 20 |
| E5, 1.5 wt-% | 0.6 | — | — | 0.02 | <1 (Ni) | 39 | 26 | 25 |
| Ni | | | | | | | | |
| E9, Co | 0.9 | — | — | 0.03 | <1 (Co) | 41 | 22 | 23 |
| E10, | 1.1 (Ru) | 1.15 | 0.19 | 0.07 | 4 (Ru) | 39 | 32 | 26 |
| RuNi | 0.9 (Ni) | | | | 0 (Ni) | | | |
| E11, | 2.5 (Pt) | 0.59 | 0.10 | 0.24 | 63 (Pt) | 38 | 24 | 28 |
| PtNi | 4.2 (Ni) | | | | 1 (Ni) | | | |
| E12, | 3.0 (Pt) | 0.91 | 0.10 | 0.24 | 70 (Pt) | 32 | 16 | 24 |
| PtCo | 3.3 (Co) | | | | 7 (Co) | | | |
| E14, 0.5 wt- | 5.0 | — | — | 0.17 | 75 (Pt) | 51 | 13 | 20 |
| % Pt | | | | | | | | |

The co-impregnation decreased the surface concentration of Pt by 1/3-1/2 on the bimetallic PtNi and PtCo catalysts, compared to the monometallic Pt catalyst, despite unchanged bulk metal loadings (Table 6). Meanwhile, the surface concentration of Ni and Co increased by a factor of 7 and 3.7 on the PtNi (E11) and PtCo (E12) catalysts, compared to the monometallic Ni and Co catalysts. For RuNi (E10), the surface concentration of Ru and Ni did not markedly change from the monometallic catalysts. The atomic ratio between the noble metal and the base metal was 5-9 times higher on the surface compared to the nominal bulk ratio. The Pt and Ru were therefore enriched on the catalyst surface. The atomic ratio of active metal(s) to the sum of Ce and Zr was the highest on the surface of the Pt-containing catalysts.

The XPS analysis indicated that the majority (63-75%) of the Pt on the surface was metallic, while the other metals were mainly oxidic (Table 6). A more detailed distribution of the oxidation states of the metals, based on the XPS analysis, is presented in Table 7. Approximately 40% of the surface Ce atoms of the CeO₂—ZrO₂ support were present as Ce³⁺ on most catalysts. The highest amounts (22-32%) of Zr in the higher binding energy state were found on the Co (E9), Ni (E5), PtNi (E11) and RuNi (E10) catalysts. The Ni (E5), PtNi (E11) and RuNi (E10) catalysts also contained a slightly higher share of surface O in OH groups (25-28%) than the other samples.

TABLE 7

| Catalyst | Oxidation state, M₁ | Oxidation state, M₂ |
|---|---|---|
| E3, Ru | Ru(0): 30%/Ru(IV): 70% | — |
| E5, 1.5 | — | Ni(0): 0%/Ni(II): 54% |
| wt-% Ni | | Ni(III): 45% |
| E9, Co | — | Co(0): 0%/Co₃O₄: 0% |
| | | CoO: 35%/Co(OH)₂: 6% |
| E10, RuNi | Ru(0): 4%/Ru(IV): 96% | Ni(0): 0%/Ni(II): 44% |
| | | Ni(III): 56% |
| E11, PtNi | Pt(0): 63%/Pt(I): 5% | Ni(0): 1%/Ni(II): 51% |
| | Pt(II): 6%/Pt(IV):11% | Ni(III): 48% |
| | Pt(mix): 15% | |
| E12, PtCo | Pt(0): 70%/Pt(I): 0% | Co(0):7%/Co₃O₄: 1% |
| | Pt(II): 10%/Pt(IV): 9% | CoO: 48%/Co(OH)₂: 44% |
| | Pt(mix): 11% | |
| E14, 0.5 | Pt(0): 75%/Pt(I): 3% | — |
| wt-% Pt | Pt(II): 2%/Pt(IV): 8% | |
| | Pt(mix): 12% | |

### Analysis of the Catalysts Comprising NiMo

Samples prepared in Example 13 and Comparative example 5 were analysed as follows.

### X-Ray Fluorescence

Prior to X-ray fluorescence analysis, the samples were fused into borate glass beads using a Katanax X-300 fusion device. A prefused, 50-50 sodium metaborate/tetraborate flux with 0.5 wt-% lithium iodide additive was used for fusion (XRFscientific). The XRF analysis itself was performed in vacuum using a Malvern Panalytical Axios mAX 3 kW device, equipped with a Rh X-ray source (60 kV, 125 mA) and a scintillation detector.

### CHNS-Analyser

A Thermo Flash Smart CHNSO Elemental Analyser was used to determine the amount of sulfur present in the transition metal sulfided catalysts. 2,5-bis(5-tert-butyl-benzoxazol-2-yl)thiophene (BBOT) was used as a calibration standard. The temperature of the furnace was 950° C., the temperature of the oven was 65° C., the carrier gas flow was 140 ml/min, the reference gas flow was 100 ml/min and the oxygen flow was 250 ml/min XRF shows that NiMo/17CeO₂—ZrO₂ had a similar Mo and Ni loading to NiMo/Al₂O₃.

In summary, the metal content for both catalyst oxide precursors appears to be similar and close to the target.

### Nitrogen Physisorption

The specific surface areas, the total pore volumes and the pore size distributions of the oxide precursors were determined using nitrogen physisorption at 77 K. The measurement was performed using a TriStar II Plus 3.03 device. Prior to the measurements, the sample was degassed for 180 min at 350° C. (10° C./min). The Brunauer-Emmett-Teller (BET) method was applied for determining the specific surface area and the Barrett-Joyner-Halenda (BJH) method (B. C Lippens, B. G Linsen, J. H. de Boer, Studies on pore systems in catalysts I. The adsorption of nitrogen; apparatus and calculation, Journal of Catalysis, Volume 3, Issue 1, 1964, Pages 32-37) was applied to determine the pore size distribution and the total pore volume.

The nitrogen physisorption results are shown below in Table 8. From the results, it can be seen that the general trend for BET surface area is: NiMo/Al₂O₃>NiMo/17CeO₂—ZrO₂. This matched the expected trend between Al₂O₃ and CeO₂—ZrO₂.

TABLE 8

| | Support | Surface | Pore | Average |
|---|---|---|---|---|
| | surface | area | volume | pore |
| | area | (BET, | (BJH, | diameter |
| Catalyst | (manufacturer) | m²/g) | cm³/g) | (BJH, nm) |
| CE5, | 155 | 142 | 0.4 | 11.0 |
| NiMo/Al₂O₃ | | | | |
| E13, | — | 61 | 0.2 | 10.3 |
| NiMo/ | | | | |
| 17CeO₂—ZrO₂ | | | | |

### X-Ray Photoelectron Spectroscopy

The sulfided catalysts were analysed using X-ray photoelectron spectroscopy (XPS). The analysis was done using a Kratos AXIS Ultra DLD X-ray photoelectron spectrometer, with an AIK-alpha X-ray source (1486.7 eV, 100 W). Survey spectra (pass energy 80 eV, step size 1.0 eV) and high-resolution spectra (pass energy 20 eV, step size 0.1 eV) were collected. The take-off angle for photoelectron collection was 90\degree and the measurements were done under ultra-high vacuum (base pressure below 10-9 Torr). The spectra were charge corrected using the C—C bonding peak (284.8 eV) of advantageous carbon as a reference. Shirley background correction was applied and the CasaXPS software package was used for data analysis. Macrofibrillar cellulose (ash-free filter paper, Whatman) was used as a reference, in order to exclude cross-contamination between samples in the analysis chamber.

Information on the sulfidation degree of Mo was provided by deconvoluting the raw Mo 3d spectra. The Mo 3d spectra was deconvoluted into several standard Gaussian-Lorentzian peaks, split due to spin-orbit splitting into doublet peaks with an inter-peak energy difference of 3.15 eV and an expected area ratio of 2:3. Three such doublet peaks should be present, corresponding to Mo (VI), Mo (V) and Mo (IV) species. These peaks were assumed to correspond to molybdenum sulfide species, molybdenum oxysulfide species and molybdenum oxide species respectively.

The Ni 2p spectra of the sulfided catalysts were deconvoluted in a similar way, in order to determine the relative amounts of nickel sulfide species, nickel oxide species and the mixed NiMoS phase. For each main peak, satellite peaks with an energy difference of 6.7 eV and an area ratio of 1:4 were as well as doublet peaks with an energy difference of 17.3 eV and a theoretically expected area ratio of 1:2 were also fitted. Once this fitting and peak assignment had been done, the relative amount of the mixed NiMOS phase can be calculated.

The results showed that there are clear differences between the Mo and Ni phases on the different catalysts. The intensities of the Mo 3d and Ni 2p peaks vary a lot, with very intense peaks on ZrO₂ and much weaker peaks on Al₂O₃.

Semi-quantitative, XPS-derived atomic surface concentrations are shown in Table 9 below. The results show that the surface concentration for both Mo and Ni for NiMo/Al₂O₃ is lower than for 17CeO₂—ZrO₂.

TABLE 9

| Catalyst | Al % | C % | Mo % | Ni % | O % | S % | Zr % | Si % | Ti % | Ce % |
|---|---|---|---|---|---|---|---|---|---|---|
| E13, | 0.0 | 10.0 | 4.9 | 0.8 | 51.6 | 8.5 | 21.7 | 0.0 | 0.0 | 2.5 |
| NiMo/ | | | | | | | | | | |
| 17CeO₂—ZrO₂ | | | | | | | | | | |
| CE5, | 36.7 | 6.0 | 1.7 | 0.2 | 52.1 | 3.3 | 0.0 | 0.0 | 0.0 | 0.0 |
| NiMo/Al₂O₃ | | | | | | | | | | |

On NiMo/CeO₂—ZrO₂, approximately 70% of Ni is in the highly active NiMOS phase, and for NiMo/Al₂O₃ only 50% of Ni has formed the desired NiMOS phase (Table 10).

TABLE 10

| Catalyst | S/Metal | MoS_{2, rel} | NiMoSᵣₑₗ |
|---|---|---|---|
| E13, NiMo/ | 1.5 | 0.60 | 0.71 |
| 17CeO₂—ZrO₂ | | | |
| CE5, NiMo/ | 1.7 | 0.56 | 0.53 |
| Al₂O₃ | | | |

### Transmission Electron Microscopy

Transmission electron microscopy (TEM) images of sulfided catalysts were taken with a JEOL JEM-2200 FS TEM microscope. The setup used a Schottky FEG emitter, an Omega type in-column energy filter and a 200 kV field emission gun. Energy-dispersive X-ray spectroscopy (EDX/EDS) spectra were also collected. The sample preparation was done by crushing the solid sample and dispersing it using acetone onto a regular copper grid (300 mesh) coated with a holey carbon support film (Agar Scientific).

A minimum of 20 images were collected for each catalyst, from which at least 350 MoS₂ stacks were counted in order to obtain statistically relevant data.

The statistical results are shown in Table 11.

TABLE 11

| | | Average | Stacking | Slab length | |
|---|---|---|---|---|---|
| | Average | slab | number | standard | Edge |
| | stacking | length | standard | deviation | dispersion |
| Catalyst | number | (nm) | deviation | (nm) | (%) |
| E13, | 2.1 | 4.7 | 1.0 | 1.1 | 23.0 |
| NiMo/ | | | | | |
| 17CeO₂—ZrO₂ | | | | | |
| CE5, | 2.1 | 5.4 | 0.8 | 1.0 | 21.2 |
| NiMo/Al₂O₃ | | | | | |

It can be concluded that the support has a significant effect on the morphology of the obtained MoS₂ phase. NiMo/17CeO₂—ZrO₂ had shorter slabs than NiMo/Al₂O₃.

The 17CeO₂—ZrO₂ support thus appeared promising, based purely on the morphology of the MoS₂ phase.

### Catalyst Testing

### Activity in Simultaneous HDN and HDO

The catalytic activity tests were carried out in a 100 ml high-pressure batch reactor, for a mixture of 54.7 mg hexadecanamide in 30 ml of decalin (decahydronaphthalene, C₁₀H₁₈) as a solvent, which corresponds to a nitrogen concentration of 100 ppm. Prior to the activity tests, 20 mg of catalyst with a particle size of 0.25-0.42 mm, was dried at 180° C. in 10 bar N₂ for 60 minutes and reduced at 350° C. in 20 bar H₂ for 60 minutes. The reaction was carried out at 300° C. under 80 bar H₂ for 60 minutes while stirring at 600 rpm, with 20 mg catalyst. The reaction products were quantified with gas chromatography (GC) and the nitrogen content of the products was measured with a commercial total nitrogen content analyser. The oxygen content of the product mixture was estimated from the GC results. The results are given below.

### Activity in HDN Alone

Some catalysts were further tested for their activity in the HDN of hexadecylamine in the same conditions, i.e. 300° C. and 80 bar H₂ for 60 minutes, stirring 600 rpm, using 20 mg catalyst and 51.8 mg hexadecylamine and 30 ml decalin as a solvent. The nitrogen content of the reaction products was measured as above. The results are given below.

### Results of Catalytic Activity

### Simultaneous HDO and HDN

All tested catalysts according to the invention were active for the simultaneous HDN and HDO of hexadecanamide.

The results for simultaneous HDO and HDN for Examples 1-3 as well as Comparative examples 1 and 2 are given below in Table 12.

TABLE 12

| | N-removal | O-removal | Conversion | Paraffin yield |
|---|---|---|---|---|
| Catalyst | (wt-%) | (wt-%) | (%) | (mol-%) |
| E1 Pt/Nb₂O₅ | 40 | 85 | 93 | 10 |
| E2 Pt/ | 49 | 78 | 93 | 26 |
| 25CeO₂—ZrO₂ | | | | |
| CE1 Pt/γ-Al₂O₃ | 35 | 47 | 70 | 12 |
| CE2 Pt/ZrO₂ | 39 | 48 | 79 | 10 |

The Pt/Nb₂O₅ (Example 1) and Pt/25CeO₂—ZrO₂ (Example 2) catalysts displayed higher conversions, higher or comparable percentual nitrogen removals, and significantly higher percentual oxygen removals than Pt/γ-Al₂O₃ (Comparative example 1) and Pt/ZrO₂ (Comparative example 2). The Pt/25CeO₂—ZrO₂ catalyst achieved a paraffin yield twice as high as the comparative catalysts.

The Pt/25CeO₂—ZrO₂ catalyst achieved the highest nitrogen removal and paraffin yield out of the catalysts in Table 12. The Pt/Nb₂O₅ catalyst was the most active in HDO, removing around 85 wt-% of the oxygen of the feed. The activity of the Pt/25CeO₂—ZrO₂ catalyst considerably exceeded the activity of the undoped Pt/ZrO₂ catalyst, especially in terms of oxygen removal. The addition of CeO₂ to the ZrO₂-matrix can thus be considered beneficial for this application.

The results for simultaneous HDO and HDN for Examples 3 and 5-9 as well as Comparative examples 3 and 4 are given below in Table 13.

TABLE 13

| | | | | | C₁₅ to | |
|---|---|---|---|---|---|---|
| | | | | | C₁₆ | C2n |
| | N- | O- | | Paraffin | paraffin | product |
| | removal | removal | Conversion | yield | ratio | yield |
| Catalyst | (wt-%) | (wt-%) | (%) | (mol-%) | (mol/mol) | (mol-%) |
| E3 0.5 wt-% | 58 | 72 | 80 | 43 | 6.3 | 4 |
| Ru/17CeO₂—ZrO₂ | | | | | | |
| E4 1 wt-% | 45 | 69 | 81 | 20 | 7.8 | 13 |
| Ni/17CeO₂—ZrO₂ | | | | | | |
| E5 1.5 wt-% | 50 | 69 | 81 | 31 | 12.3 | 8 |
| Ni/17CeO₂—ZrO₂ | | | | | | |
| E6 5 wt-% | 45 | 65 | 80 | 20 | 8.9 | 13 |
| Ni/17CeO₂—ZrO₂ | | | | | | |
| E7 10 wt-% | 47 | 64 | 78 | 23 | 9.5 | 10 |
| Ni/17CeO₂—ZrO₂ | | | | | | |
| E8 Pt/17CeO₂—ZrO₂ | 52 | 60 | 90 | 12 | 0.5 | 12 |
| E9 | 30 | 55 | 69 | 2 | 1.0 | 14 |
| Co/17CeO₂—ZrO₂ | | | | | | |
| CE3 1 wt-% | 53 | 60 | 69 | 47 | 5.0 | 2 |
| Ru/ZrO₂ | | | | | | |
| CE4 1 wt-% | 31 | 46 | 66 | 4 | 4.7 | 10 |
| Ni/ZrO₂ | | | | | | |

The Ru/17CeO₂—ZrO₂ catalyst (Example 3), even with only half of the active metal compared to Ru/ZrO₂ (Comparative example 3), had a higher conversion as well as nitrogen and oxygen removal than the comparative catalyst. The same was true for the Ni/17CeO₂—ZrO₂ catalyst (Example 4) when compared to Comparative example 4 (Ni/ZrO₂ with same nickel loading).

Ruthenium was found to be the most active metal for simultaneous HDN and HDO in the present experiments. The CeO₂—ZrO₂ support considerably enhanced the activity of the Ru and Ni catalysts.

Indeed, the 1 wt-% Ni/17CeO₂—ZrO₂ catalyst removed 14 pp (percentage point) more nitrogen, 23 pp more oxygen, had a 15 pp higher conversion and 16 pp higher paraffin yield than the 1 wt-% Ni/ZrO₂ catalyst. For the Ni/17CeO₂—ZrO₂ catalysts, the optimal active metal loading was found to be 1.5 wt-% Ni. The 1.5 wt-% Ni/17CeO₂—ZrO₂ displayed a higher activity level and higher paraffin selectivity than all other noble metals except for ruthenium, when compared to ZrO₂ support and 1 wt-% loading.

For ruthenium, the 17CeO₂—ZrO₂ support enabled decreasing the loading compared to undoped ZrO₂, while still delivering a higher conversion, nitrogen removal and oxygen removal, and a similar paraffin yield. A Ru/17CeO₂—ZrO₂ catalyst is therefore expected to give a higher paraffin yield than a Ru/ZrO₂ catalyst with an identical active metal loading, as observed with Ni.

Furthermore, the Ru/17CeO₂—ZrO₂ and Ni/17CeO₂—ZrO₂ catalysts produced the Cn-1 paraffin with a high selectivity, which may be an advantage in hydrotreating heavier feedstocks. Doping the ZrO₂ support with CeO₂ improved the conversion, oxygen-removal and nitrogen removal. For a given active metal loading, the CeO₂—ZrO₂ support also improved the paraffin yield compared to undoped ZrO₂. For the Ru-based catalysts, the low selectivity towards C2n condensation products should be considered noteworthy.

The Pt/17CeO₂—ZrO₂ catalyst and Co/17CeO₂—ZrO₂ catalyst had lower paraffin yields than the other catalysts tested in this series.

The results for simultaneous HDO and HDN for Examples 10-12 are given below in Table 14.

TABLE 14

| | | | | | C15 to | |
|---|---|---|---|---|---|---|
| | | | Con- | | C16 | C₂ₙ |
| | N- | O- | ver- | Paraffin | paraffin | product |
| | removal | removal | sion | yield | ratio | yield |
| Catalyst | (wt-%) | (wt-%) | (%) | (mol-%) | (mol/mol) | (mol-%) |
| E10 | 76 | 90 | 93 | 69 | 16.5 | 2 |
| RuNi/ | | | | | | |
| 17CeO₂—ZrO₂ | | | | | | |
| E11 | 60 | 82 | 93 | 46 | 7.1 | 10 |
| PtNi/ | | | | | | |
| 17CeO₂—ZrO₂ | | | | | | |
| E12 | 49 | 72 | 90 | 19 | 2.6 | 17 |
| PtCo/ | | | | | | |
| 17CeO₂—ZrO₂ | | | | | | |

All tested inventive catalysts again displayed activity for simultaneous HDN and HDO of hexadecanamide. The performance of RuNi/17CeO₂—ZrO₂ was superior compared to the others in terms of nitrogen removal, oxygen removal and paraffin yield, followed by PtNi/17CeO₂—ZrO₂. Furthermore, the bimetallic catalysts had a higher conversion as well as nitrogen and oxygen removals than the same monometallic catalysts.

Table 15 shows the Lewis acid site concentration of some catalysts as well as for the support alone (17CeO₂—ZrO₂), and the total paraffin yield and nitrogen removal in the hydrotreatment of n-hexadecanamide. The Lewis acid site concentration refers to the amount of pyridine adsorbed on Lewis acid sites. The total paraffin yield comprises the sum of the n-pentadecane and n-hexadecane. The hydrotreating experiments were carried out in a batch reactor at 300° C. at 80 bar H₂ with a reaction time of 60 minutes, using 20 mg of catalyst, an initial nitrogen concentration of 100 ppm and 30 ml decalin as a solvent.

TABLE 15

| | Lewis acid site | Total paraffin | Nitrogen |
|---|---|---|---|
| | concentration | yield | removal |
| Sample | (μmol/g_{cat}) | (%) | (%) |
| 17CeO₂-ZrO₂ | 60 | 1 | 33 |
| E7 Pt/ | 40 | 12 | 52 |
| 17CeO₂—ZrO₂ | | | |
| E3 0.5 wt-% | 50 | 43 | 58 |
| Ru/17CeO₂—ZrO₂ | | | |
| E5 1.5 wt-% | 140 | 31 | 50 |
| Ni/17CeO₂—ZrO₂ | | | |
| E9 Co/ | 80 | 2 | 30 |
| 17CeO₂—ZrO₂ | | | |
| E10 RuNi/ | 160 | 69 | 76 |
| 17CeO₂—ZrO₂ | | | |
| E11 PtNi/ | 130 | 46 | 60 |
| 17CeO₂—ZrO₂ZrO2 | | | |
| E12 PtCo/ | 90 | 19 | 49 |
| 17CeO₂—ZrO₂ | | | |

1. A method for simultaneously lowering oxygen and nitrogen content in a feedstock, the feedstock comprising renewable and/or recycled feedstock for producing paraffinic hydrocarbons, wherein a catalyst comprising at least one active metal and a support capable of undergoing reversible redox reactions is used during the production of the paraffinic hydrocarbons, wherein the support comprises at least one of cerium dioxide and niobium pentoxide.

2. The method according to claim 1, wherein the support is selected from a group consisting of cerium dioxide, cerium dioxide-zirconium dioxide, cerium dioxide-alumina, cerium dioxide-silica, niobium pentoxide, niobium pentoxide-zirconium dioxide, niobium pentoxide-alumina, niobium pentoxide-silica and mixtures of at least two of cerium dioxide, niobium pentoxide, and titanium dioxide with or without at least one of zirconium dioxide, alumina, and silica.

3. The method according to claim 1, wherein the active metal comprises one active metal.

4. The method according to claim 1, wherein the active metal comprises two active metals.

5. The method according to claim 1, wherein the active metal comprises more than two active metals.

6. The method according to claim 1, wherein the active metal is selected from noble metals, transition metals, and combinations thereof.

7. The method according to claim 6, wherein the transition metal is selected from a group consisting of cobalt, tungsten, nickel, and molybdenum.

8. The method according to claim 6, wherein the noble metal is selected from a group consisting of platinum, rhodium, ruthenium, and palladium.

9. The method according to claim 1, wherein the catalyst comprises one or two or more than two active metals on a support capable of undergoing reversible redox reactions during the production of the paraffinic hydrocarbons, wherein the catalyst is sulfided prior to or during the production of the paraffinic hydrocarbons.

10. The method according to claim 1, wherein the support is selected from cerium dioxide-zirconium dioxide, and mixtures of at least two of cerium dioxide-zirconium dioxide, niobium pentoxide, and titanium dioxide.

11. The method according to claim 1, wherein the catalyst is selected from a group consisting of Pt/Nb₂O₅, Pt/CeO₂—ZrO₂, Ru/Nb₂O₅, Ru/CeO₂—ZrO₂, Ni/Nb₂O₅, Ni/CeO₂—ZrO₂, RuNi/CeO₂—ZrO₂, PtNi/CeO₂—ZrO₂, PtNi/Nb₂O₅, and RuNi/Nb₂O₅.

12. The method according to claim 1, wherein the catalyst is selected from a group consisting of NiMo/CeO₂—ZrO₂ NiMo/Nb₂O₅, CoMo/CeO₂—ZrO₂, CoMo/Nb₂O₅, NiW/CeO₂—ZrO₂ and NiW/Nb₂O₅.

13. The method according to claim 1, wherein the amount of the active metal on the support is 0.1-25 wt-% of the total weight of the catalyst.

14. The method according to claim 1, wherein when cerium dioxide and/or niobium pentoxide is used in combination with alumina or silica, the amount of cerium dioxide and/or niobium pentoxide is over 1 wt-% of the total weight of the support, preferably 1-40 wt-% of the total weight of the support, more preferably 10-30 wt-% of the total weight of the support, or 5-20 wt-% of the total weight of the support.

15. The method according to claim 1, wherein the feedstock comprises wood based oils such as crude tall oil, tall oil pitch, crude fatty acid, tall oil fatty acid, distilled tall oil; acid oils such as acidulated soapstock; technical corn oil; plant oil from plants of the family Brassicaceae; palm effluent sludge; used cooking oil; gutter oil; brown grease; algae; and any combination thereof.

16. The method according to claim 1, wherein the recycled feedstock comprises recycled liquefied plastics, municipal solid waste, and/or synthetic hydrocarbons.

17. The method according to claim 1, wherein the production of the paraffinic hydrocarbons comprises hydrotreatment, preferably hydrogenolysis, hydrodeoxygenation, hydrodenitrogenation, hydrodearomatisation, hydrodesulfurisation, hydroisomerisation, hydrocracking, and combinations thereof.

18. The method according to claim 1, wherein the production of the paraffinic hydrocarbons is carried out by
i. pre-treating the feedstock;
ii. subjecting the pre-treated feedstock to hydrotreatment using the catalyst comprising at least one active metal and a support capable of undergoing reversible redox reactions; and
iii. hydroisomerising the hydrotreated feedstock to obtain the paraffinic hydrocarbons.

19. The method according to claim 17, wherein the hydrotreatment is carried out at a temperature of 200 to 500° C., a pressure of 1 to 20 MPa, and a hydrogen flow of 100 to 1500 N1 H2/1 feed.

20. Use of a catalyst comprising at least one active metal and a support capable of undergoing reversible redox reactions for simultaneously lowering oxygen and nitrogen content in a renewable and/or recycled feedstock, wherein the support comprises at least one of cerium dioxide and niobium pentoxide.
